(19) United States
(12) Patent Application Publication
(10) Pub. No.: US 2013/0235056 A1
(43) Pub. Date: Sep. 12, 2013

(54) SYSTEM AND METHOD FOR MANAGING DATA OF VIDEO CARD

(71) Applicant: HON HAI PRECISION INDUSTRY CO., LTD., New Taipei (TW)

(72) Inventor: CHIH-HUANG WU, New Taipei (TW)

(73) Assignee: HON HAI PRECISION INDUSTRY CO., LTD., New Taipei (TW)

(21) Appl. No.: 13/775,302

(22) Filed: Feb. 25, 2013

(30) Foreign Application Priority Data
Mar. 12, 2012 (TW) 101108207

(51) Int. Cl. G06T 1/60

(52) U.S. Cl. CPC G06T 1/60
USPC 345/547

(57) ABSTRACT

A video card includes a memory which has a plurality of memory bank. The video further includes a check unit which is used to check whether there is a malfunctioning bit in a memory bank. If there is at least one malfunctioning bit, a malfunctioning memory bank that contains the malfunctioning bit is determined. When the video card is written to or read from, the malfunctioning memory bank is not written to or read from according a bank address and an offset address of the malfunctioning memory bank and data is written to or read from other memory bank that are functioning.

### BACKGROUND

1. Technical Field

Embodiments of the present disclosure relate to data management systems and methods, and particularly to a system and a method for managing data of a video card.

2. Description of Related Art

When a memory of a video card is malfunctioning, images displayed on a display may be distorted. Even when only one bit of the video memory malfunctions, the images may be so distorted that the video card itself may need to be replaced. This is an inconvenience.

### BRIEF DESCRIPTION OF THE DRAWINGS

FIG. 1 is a block diagram of one embodiment of a video card including a management system.

FIG. 2 is a block diagram of one embodiment of function modules of the management system in FIG. 1.

FIG. 3 is a flowchart illustrating one embodiment of a method for managing data of a video card.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware unit, or to a collection of software instructions, written in a programming language. One or more software instructions in the modules may be embedded in firmware unit, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

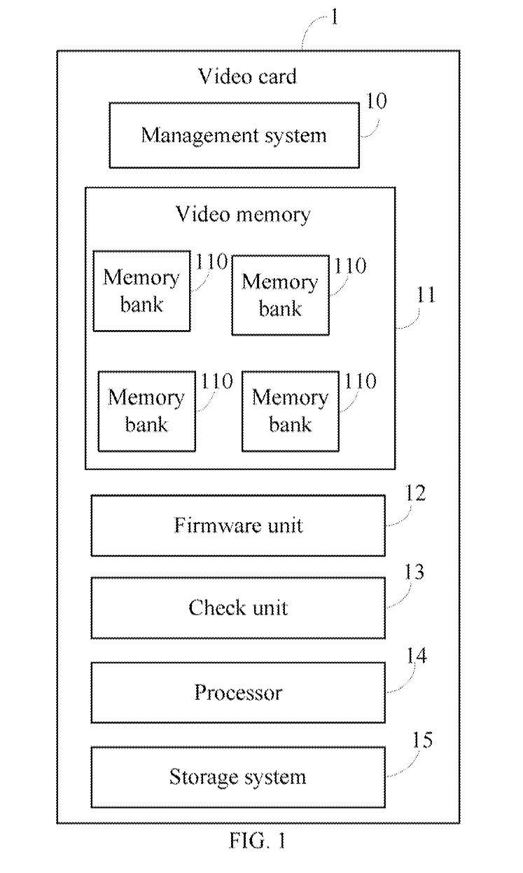

FIG. 1 is a block diagram of one embodiment of a video card 1. The video card 1 includes a management system 10, a video memory 11, a firmware unit 12 and a check unit 13. The video memory 11 includes one or more memory bank 110. Each memory bank 110 includes a plurality of bits. A number of the bits of each memory bank 110 denotes a capacity of each memory bank 110. For example, each memory bank 110 may have 32 bits. As shown in FIG. 1, the video memory 11 includes four memory banks 110. The capacity of the video memory 110 will therefore be 128 bits. The firmware unit 12 stores information of the video card 1. The information of the video card 1 may include a capacity, a model of the video card 1, a number of the memory banks 110, a bank address and an offset address of each memory bank 110, for example. The check unit 13 determines whether any bit of a memory bank 110 is malfunctioning. In an embodiment, the video card 1 includes at least one processor 14 and a storage system 15.

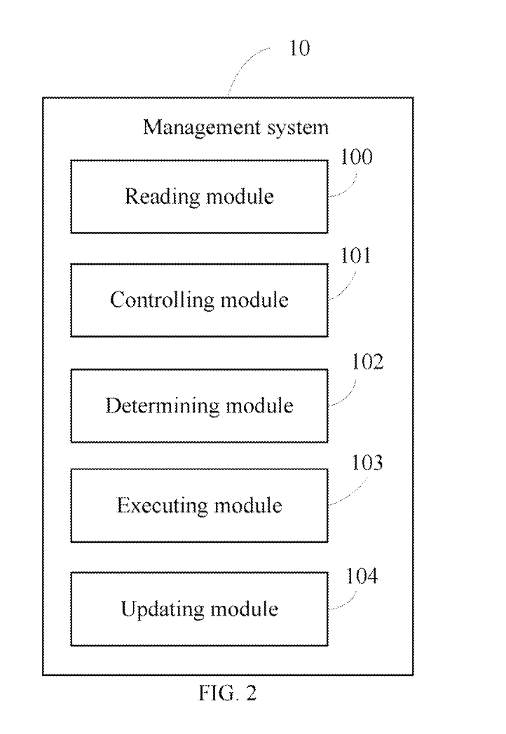

As shown in FIG. 2, the management system 10 includes a reading module 100, a controlling module 101, a determining module 102, an executing module 103, and an updating module 104. The one or more modules may comprise computerized instructions in the form of one or more programs that are stored in the storage system 15 and executed by the at least one processor 14 to provide functions of the modules 100-104.

The reading module 100 reads the bank address and the offset address of each memory bank 110 from the video memory 11.

The controlling module 101 controls the check unit 13 to detect if any bit of the video memory 11 malfunctions. If a bit of the video memory 11 malfunctions, the bit cannot be accessed, such as reading data from the bit or writing data into the bit. For example, the check unit 13 sends data to each bit and receives data from the bit. If the received data is the same as the sent data, the check unit 13 determines that the bit is functioning. If the received data is different from the sent data, the check unit 13 determines that the bit is malfunctioning.

If a bit of the video memory 11 malfunctions, the determining module 102 determines a malfunctioning memory bank 110 which contains the malfunctioning bit.

When the video card 1 is being written to or read from, the executing module 103 prevents the malfunctioning memory bank 110 from being written to or read from according to the bank address and the offset address of the malfunctioning memory bank 110. In one embodiment, the video card 1 is written to or read from in the sequence of the bank addresses of each memory bank 110. When the bank address of the malfunctioning memory bank 110 is accessed in its turn, the malfunctioning memory bank 110 will not be written to or read from and a next memory bank 110 of the video card 1 is written to or read from instead.

The updating module 104 updates parameters of the video card 1 according to the number of the memory banks 110 that are functioning. For example, if the number of the memory banks 110 is 4 and the capacity of each memory bank 110 is 32 bits, the initial capacity of the video card 1 is 128 bits. If two memory banks 110 are malfunctioning as malfunctioning memory banks, the number of the memory banks 110 that are functioning is 2. The updating module 104 thus updates the capacity of the video card 1 to 64 bits.

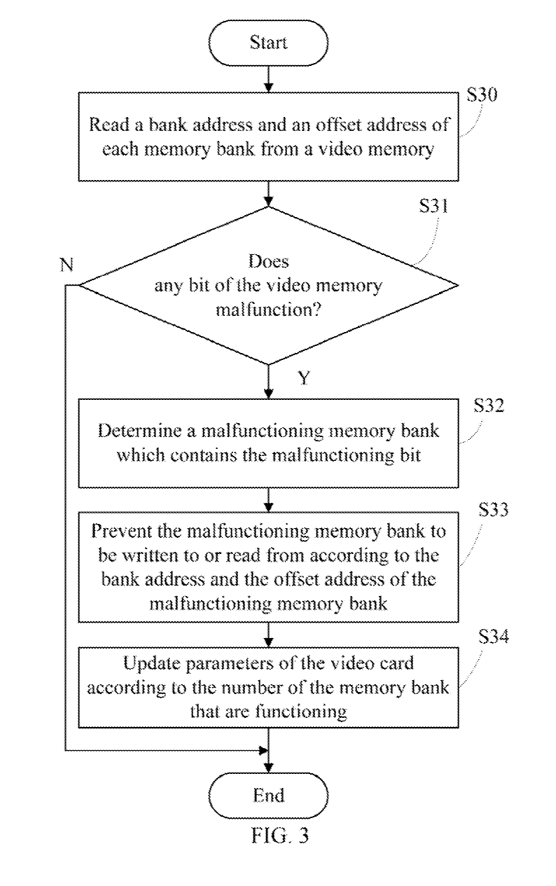

FIG. 3 is a flowchart illustrating a method for managing data of a video card 1 in FIG. 1. Depending on the embodiment, additional steps may be added, others removed, and the ordering of the steps may be changed.

In step S30, the reading module 100 reads a bank address and an offset address of each memory bank 110 from the video memory 11 of the video card 1.

In step S31, the controlling module 101 controls the check unit 13 to detect if any bit of the video memory 11 malfunctions. If a bit of the video memory 11 malfunctions, step S32 is implemented. If no bit of the video memory 11 malfunctions, procedure ends.

In step S32, the determining module 102 determines a malfunctioning memory bank 110 containing the malfunctioning bit.

In step S33, when the video card 1 is being written to or read from, the executing module 103 prevents the malfunctioning memory bank 110 being written to or read from according to the bank address and the offset address of the malfunctioning memory bank 110.

In step S34, the updating module 104 updates parameters of the video card 1 according to the number of the memory banks 110 that are functioning.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A video card, comprising:
video memory that comprising one or more memory banks;
a storage system;
at least one processor; and
one or more programs stored in the storage system and executed by the at least one processor, the one or more programs comprising:
a reading module that reads a bank address and an offset address of each memory bank of the video memory;
a controlling module that controls a check unit of the video card to detect whether any bit of the video memory malfunctions;
a determining module that determines a malfunctioning memory bank that a bit belongs to when the bit malfunctions; and
an executing module that prevents the determined memory bank to be written to or read from according to the bank address and the offset address of the malfunctioning memory bank when the video card is being written or read.

2. The video card as described in claim 1, wherein the video card further comprises an updating module that updates parameters of the video card according to the number of the memory bank that are functioning.

3. The video card as described in claim 2, wherein the parameters of the video card comprises a capacity of the video card.

4. A method being executed by a processor of a video card for managing data of a video card, comprising:
reading a bank address and an offset address of each memory bank of a video memory of the video card;
controlling a check unit of the video card to detect whether any bit of the video memory malfunctions;
determining a malfunctioning memory bank that a bit belongs to when the bit malfunctions; and
preventing the determined memory bank to be written to or read from according to the bank address and the offset address of the malfunctioning memory bank when the video card is being written or read.

5. The method as described in claim 4, wherein the method further comprises:
updating parameters of the video card according to the number of the memory bank that are functioning.

6. The method as described in claim 5, wherein the parameters of the video card comprises a capacity of the video card.

7. A non-transitory storage medium having stored thereon instructions that, when executed by a processor, causes the processor to perform a method for managing data of a video card, the method comprising:
reading a bank address and an offset address of each memory bank of a video memory of the video card;
controlling a check unit of the video card to detect whether any bit of the video memory malfunctions;
determining a malfunctioning memory bank that a bit belongs to when the bit malfunctions; and
preventing the determined memory bank to be written or read according to the bank address and the offset address of the malfunctioning memory bank when the video card is being written or read.

8. The non-transitory storage medium as described in claim 7, wherein the method further comprises:
updating parameters of the video card according to the number of the memory bank that are functioning.

9. The non-transitory storage medium as described in claim 7, wherein the parameters of the video card comprises a capacity of the video card.
